(19) United States
(12) Patent Application Publication
(10) Pub. No.: US 2026/0171823 A1
(43) Pub. Date: Jun. 18, 2026

(54) BATTERY CELL MONITORING DEVICE EQUIPPED WITH AN ELECTRICAL OVERSTRESS (EOS) PROTECTION CIRCUIT

(71) Applicants: HYUNDAI MOTOR COMPANY, Seoul (KR); KIA CORPORATION, Seoul (KR)

(72) Inventors: Woocheol Shin, Hwaseong-si (KR); SungWook An, Hwaseong-si (KR); Jonghu Yoon, Hwaseong-si (KR); Jun Baek, Hwaseong-si (KR)

(73) Assignees: HYUNDAI MOTOR COMPANY, Seoul (KR); KIA CORPORATION, Seoul (KR)

(21) Appl. No.: 19/231,146

(22) Filed: Jun. 6, 2025

(30) Foreign Application Priority Data
Dec. 17, 2024 (KR) 10-2024-0188520

(51) Int. Cl. H02J 7/00

(52) U.S. Cl. CPC H02J 7/64; H02J 7/52; H02J 7/62; H02J 7/80

(57) ABSTRACT

A battery cell monitoring device includes a cell monitoring circuit configured to monitor each of a plurality of battery cells included in a battery module and an electrical overstress (EOS) protection circuit configured to protect the cell monitoring circuit from external EOS. The EOS protection circuit is connected between an uppermost terminal of the cell monitoring circuit, which is connected to a positive electrode of an uppermost battery cell of the battery module, and a ground terminal of the cell monitoring circuit, which is connected to a negative electrode of a bottommost battery cell of the battery module. The battery cell monitoring device further includes a first bypass circuit configured to bypass the external EOS. The first bypass circuit is connected between a positive electrode of a next-uppermost battery cell of the battery module and the uppermost terminal of the cell monitoring circuit.

### CROSS-REFERENCE TO RELATED APPLICATION

This present application claims the benefit of and priority to Korean Patent Application No. 10-2024-0188520, filed on Dec. 17, 2024 in the Korean Intellectual Property Office, the entire contents of which are hereby incorporated herein by reference.

### TECHNICAL FIELD

The present disclosure relates to a battery cell monitoring device equipped with an electrical overstress (EOS) protection circuit, and more specifically, to a battery cell monitoring device equipped with an EOS protection circuit for protecting the battery cell monitoring device from external EOS.

### BACKGROUND

As customer demand for electric vehicles increases, not only the battery systems of electric vehicles but also the systems of high-voltage electrical components such as motors and inverters are becoming increasingly complex.

Electric vehicles are composed of complex systems, which, unlike other electric devices, are installed in confined spaces (e.g., a common ground (GND)) and exposed to harsh conditions (e.g., vibration and high power). As a result, unexpected electrical noise (electrical overstress, EOS) occurs frequently.

Therefore, the battery system, which serves as the energy source for the high-voltage system of electric vehicles, must withstand the electrical noise generated by these high-voltage electrical components.

A typical battery cell monitoring device is directly connected to a plurality of battery cells that make up the high-voltage battery and performs the role of monitoring the battery cells. For the battery cell monitoring device to monitor the battery cells properly, it must not be damaged by the high-voltage electrical noise introduced to the battery cells. To address this, typical battery cell monitoring devices are equipped with an EOS protection circuit to prevent high-voltage electrical noise.

However, in the case of the EOS protection circuit based on existing technology, when the uppermost or bottommost fuse among the sensing line fuses of the battery module is blown, the EOS protection circuit of the battery cell monitoring device cannot operate normally.

Accordingly, when the external EOS occurs, the battery cell monitoring device based on existing technology has a significant drawback of being highly vulnerable to the EOS. As a result, the battery cell monitoring device may be damaged, potentially leading to serious issues such as battery cell overheating or fire. The external EOS may be generated, for example, by high-voltage electrical components such as motors and inverters, busbar vibrations, or relay on/off operations.

### SUMMARY

The present disclosure is directed to providing a battery cell monitoring device equipped with an EOS protection circuit that operates normally even when an uppermost fuse and/or a bottommost fuse among sensing line fuses of a battery module is blown.

Additionally, the present disclosure is directed to providing a battery cell monitoring device equipped with an EOS protection circuit that includes a bypass circuit to bypass EOS introduced from the battery module to the EOS protection circuit, thereby protecting the battery cell monitoring device.

The technical problems to be solved by the present disclosure are not limited to the aforementioned problems. Other aspects and advantages not mentioned herein should be more clearly understood from the following description, and become more apparent from the described example embodiments. Moreover, aspects of the present disclosure may be realized by the means and combinations thereof indicated in claims.

According to an aspect of the present disclosure, a battery cell monitoring device is provided. The battery cell monitoring device includes a cell monitoring circuit configured to monitor each of a plurality of battery cells included in a battery module and an electrical overstress (EOS) protection circuit configured to protect the cell monitoring circuit from external EOS. The EOS protection circuit is connected between i) an uppermost terminal of the cell monitoring circuit, wherein the uppermost terminal of the cell monitoring circuit is connected to a positive electrode of an uppermost battery cell of the battery module and ii) a ground terminal of the cell monitoring circuit, wherein the ground terminal of the cell monitoring circuit is connected to a negative electrode of a bottommost battery cell of the battery module. The battery cell monitoring device also includes a first bypass circuit configured to bypass the external EOS. The first bypass circuit is connected between a positive electrode of a next-uppermost battery cell of the battery module and the uppermost terminal of the cell monitoring circuit.

The first bypass circuit may include a first Schottky diode connected between a positive electrode of the next-uppermost battery cell of the battery module and the uppermost terminal of the cell monitoring circuit.

The first bypass circuit may further include a second Schottky diode connected between the positive electrode of the uppermost battery cell of the battery module and the uppermost terminal of the cell monitoring circuit.

The battery cell monitoring device may further include a second bypass circuit connected between the ground terminal of the cell monitoring circuit and a positive electrode of the bottommost battery cell of the battery module to bypass the external EOS.

The second bypass circuit may include a third Schottky diode connected between the ground terminal of the cell monitoring circuit and the positive electrode of the bottommost battery cell of the battery module.

According to another aspect of the present disclosure, another battery cell monitoring device is provided. The battery cell monitoring device includes a cell monitoring circuit configured to monitor each of a plurality of battery cells included in a battery module and an electrical overstress (EOS) protection circuit configured to protect the cell monitoring circuit from external EOS. The EOS protection circuit is connected between i) an uppermost terminal of the cell monitoring circuit, wherein the uppermost terminal of the cell monitoring circuit is connected to a positive electrode of the uppermost battery cell of the battery module and ii) a ground terminal of the cell monitoring circuit, wherein the ground terminal of the cell monitoring circuit is connected to a negative electrode of a bottommost battery cell of the battery module. The battery cell monitoring device also includes a bypass circuit configured to bypass the external EOS. The bypass circuit is connected between the ground terminal of the cell monitoring circuit and a positive electrode of the bottommost battery cell of the battery module.

The bypass circuit may include a Schottky diode connected between the ground terminal of the cell monitoring circuit and a positive electrode of the bottommost battery cell of the battery module.

According to embodiment of the present disclosure, even when the uppermost fuse and/or the bottommost fuse among the sensing line fuses of the battery module are blown, the EOS protection circuit operates normally, thereby protecting the battery cell monitoring device from external EOS.

As a result, it is possible to prevent the battery cell monitoring device from burning and breaking down, enabling the prevention of battery cell overheating or fire in advance.

### BRIEF DESCRIPTION OF THE DRAWINGS

The foregoing and other aspects, features, and advantages, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a schematic diagram showing a battery cell monitoring device equipped with a conventional EOS protection circuit.

FIG. 2 is a diagram illustrating the effect of EOS on a battery cell monitoring device equipped with a conventional EOS protection circuit when the uppermost fuse is blown.

FIG. 3 is a diagram illustrating the effect of EOS on a battery cell monitoring device equipped with a conventional EOS protection circuit when the bottommost fuse is blown.

FIG. 4 is a schematic diagram showing a battery cell monitoring device equipped with an EOS protection circuit according to an embodiment of the present disclosure.

FIG. 5 is a diagram illustrating the effect of EOS on a battery cell monitoring device equipped with an EOS protection circuit according to an embodiment of the present disclosure when the uppermost fuse is blown.

FIG. 6 is a diagram illustrating the effect of EOS on a battery cell monitoring device equipped with an EOS protection circuit according to an embodiment of the present disclosure when the bottommost fuse is blown.

### DETAILED DESCRIPTION

Hereinafter, embodiments of the present document are described in detail with reference to the accompanying drawings. Like reference numerals designate like elements, and redundant descriptions thereof have been omitted. Further, suffixes for components, such as “module” and a “unit”, used in the following description are given or mixed and used for ease of explanation and do not have a meaning or role distinguished from each other in themselves. In addition, in in the following description, where it was determined that a detailed description of a known configuration or function may unnecessarily obscure the gist of the present disclosure, the detailed description thereof has been omitted. Furthermore, it should be understood that the appended drawings are intended only to enhance understanding of the embodiments disclosed in the present document and do not limit the technical principles and scope of the present disclosure. Rather, it should be understood that the appended drawings include all of the modifications, equivalents or substitutes described by the technical principles and belonging to the technical scope of the present disclosure.

Although the terms first, second, and the like, may be used herein to describe various elements, these elements are not limited by these terms. These terms are generally only used to distinguish one element from another.

When an element or layer is referred to as being “on,” “engaged to,” “connected to,” or “coupled to” another element or layer, it may be directly on, engaged, connected, or coupled to the other element or layer, or one or more intervening elements or layers may be present. In contrast, when an element is referred to as being “directly on,” “directly engaged to,” “directly connected to,” or “directly coupled to” another element or layer, there may be no intervening elements or layers present.

When a component, controller, device, element, apparatus, module, unit or the like of the present disclosure is described as having a purpose or performing an operation, function, or the like, the component, controller, device, element, apparatus, module, unit or the like should be considered herein as being “configured to” meet that purpose or to perform that operation or function. Each component, unit, controller, device, element, apparatus, module, unit and the like may separately embody or be included with a processor and a memory, such as a non-transitory computer readable media, as part of the apparatus.

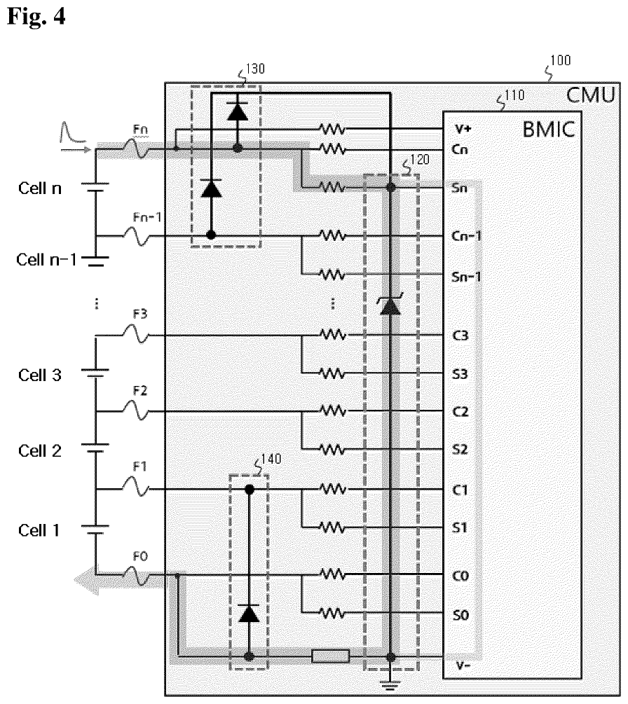

A battery cell monitoring device equipped with an EOS protection circuit according to an embodiment of the present disclosure is described in detail more below with reference to FIGS. 4-6.

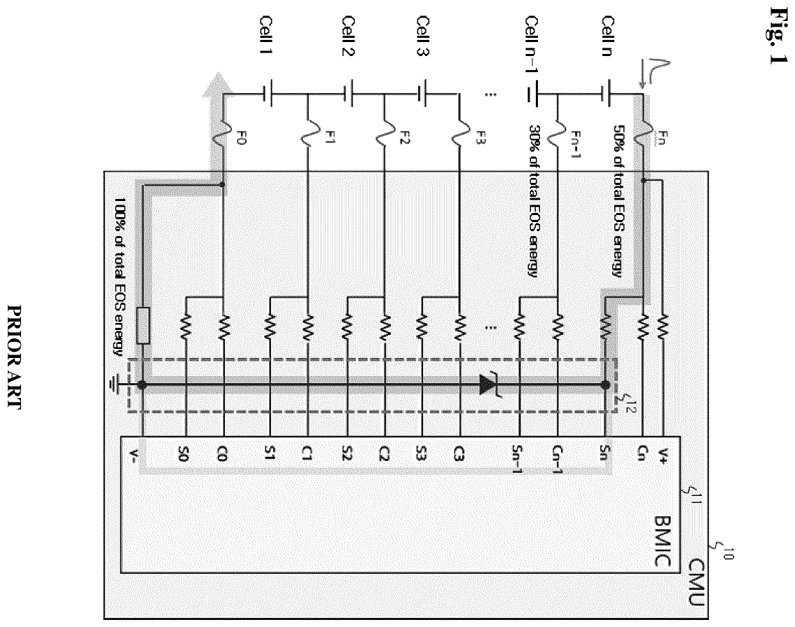

First, with reference to FIGS. 1-3, a battery cell monitoring device equipped with a conventional EOS protection circuit is described.

FIG. 1 is a schematic diagram showing a battery cell monitoring device equipped with a conventional EOS protection circuit.

Referring to FIG. 1, a battery cell monitoring device 10 may include a cell monitoring circuit 11, an EOS protection circuit 12, and the like.

The cell monitoring circuit 11 is a circuit that monitors each of a plurality of battery cells included in a battery module.

For example, the cell monitoring circuit 11 monitors the status of n battery cells Cell 1 Cell n, where n is a natural number, included in the battery module and performs cell balancing. To achieve this, the cell monitoring circuit 11 is equipped with n+1 voltage sensing terminals C0-Cn and n+1 cell balancing terminals S0-Sn.

The n+1 voltage sensing terminals C0-Cn are connected to positive and negative electrodes of the n battery cells Cell 1-Cell n through n+1 fuses F0-Fn to sense the voltage of the n battery cells.

Similarly, the n+1 cell balancing terminals S0-Sn are connected to the positive and negative electrodes of the n battery cells Cell 1-Cell n through the n+1 fuses F0-Fn to perform cell balancing for the n battery cells.

The EOS protection circuit 12 is a circuit for protecting the cell monitoring circuit 11 from external EOS.

For example, the EOS protection circuit 12 is connected between an uppermost terminal Sn of the cell monitoring circuit 11 and a ground terminal v- of the cell monitoring circuit 11 to protect the cell monitoring circuit 11 from the external EOS. The uppermost terminal Sn is connected to a positive electrode of an uppermost battery cell Cell n of the battery module through an uppermost fuse Fn, and the ground terminal v- is connected to a negative electrode of a bottommost battery cell Cell 1 of the battery module through a bottommost fuse F0.

When the EOS is introduced from the outside, the largest amount of EOS (e.g., approximately 50% of the total EOS energy) flows in through the uppermost fuse Fn, which is connected to the positive electrode of the uppermost battery cell Cell n of the battery module. The next largest amount of EOS (e.g., approximately 30% of the total EOS energy) flows in through a next-uppermost fuse Fn-1, which is connected to a positive electrode of a next-uppermost battery cell Cell n−1 of the battery module. In this manner, the amount of EOS introduced through each fuse F1-Fn progressively decreases, and the EOS introduced through the fuses flows into the battery cell monitoring device 10.

When the uppermost fuse Fn and the bottommost fuse F0 are in a normal state, as shown in FIG. 1, most of the introduced EOS passes through the EOS protection circuit 12 and is discharged to the outside. As a result, only a portion of the EOS affects the cell monitoring circuit 11, thereby protecting the cell monitoring circuit 11.

However, when the uppermost fuse Fn and/or the bottommost fuse F0 is blown, most of the introduced EOS passes through the cell monitoring circuit 11, causing the cell monitoring circuit 11 to be damaged.

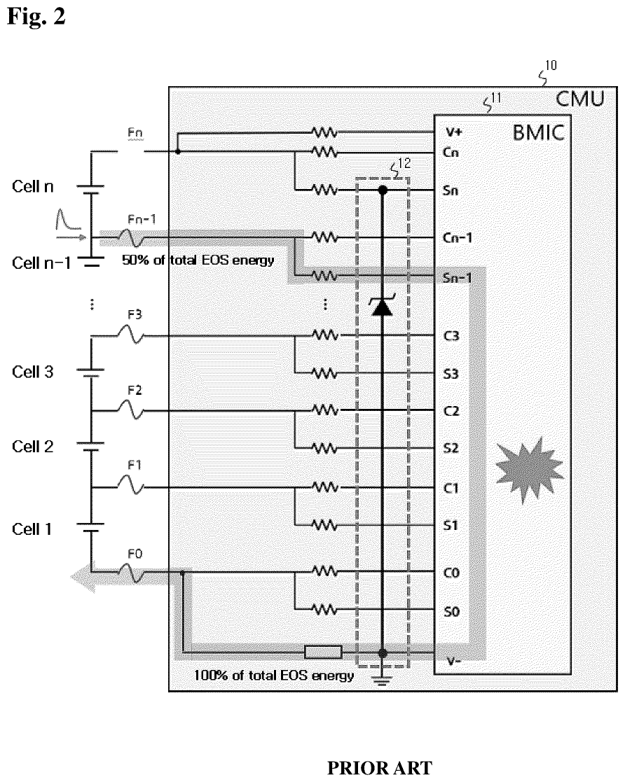

FIG. 2 is a diagram illustrating the effect of EOS on the battery cell monitoring device equipped with the conventional EOS protection circuit when the uppermost fuse is blown.

As shown in FIG. 2, when the uppermost fuse Fn connected to the positive electrode of the uppermost battery cell Cell n of the battery module is blown, most of the introduced EOS flows into the cell monitoring circuit 11 through the next-uppermost fuse Fn-1, which is connected to the positive electrode of the next-uppermost battery cell Cell n−1 of the battery module. However, since the EOS protection circuit 12 is connected to the uppermost terminal Sn of the cell monitoring circuit 11, which is connected to the blown uppermost fuse Fn, most of the EOS bypasses the EOS protection circuit 12 and directly passes through the cell monitoring circuit 11, causing the cell monitoring circuit 11 to be damaged.

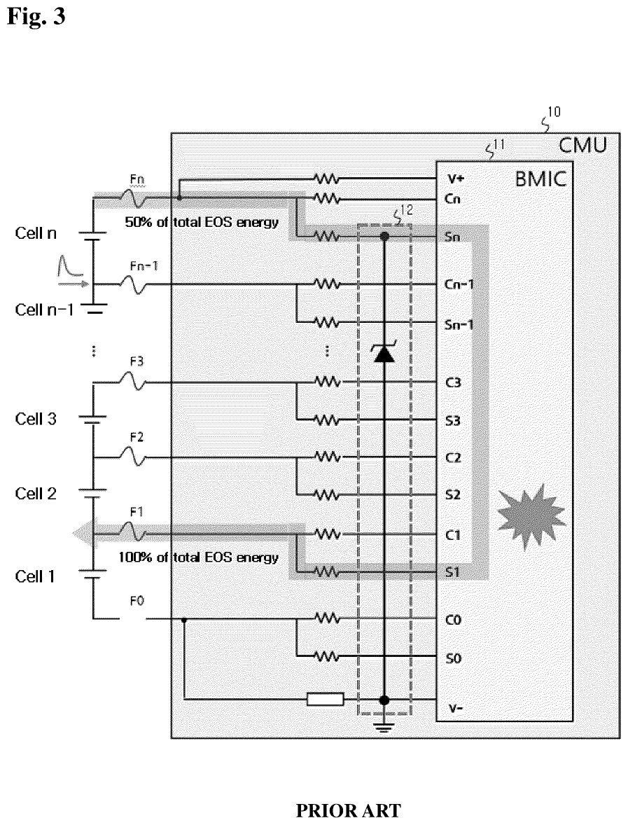

FIG. 3 is a diagram illustrating the effect of EOS on the battery cell monitoring device equipped with the conventional EOS protection circuit when the bottommost fuse is blown.

As shown in FIG. 3, when the bottommost fuse F0 connected to the negative electrode of the bottommost battery cell Cell 1 of the battery module is blown, most of the introduced EOS flows into the cell monitoring circuit 11 through the uppermost fuse Fn, which is connected to the positive electrode of the uppermost battery cell Cell n of the battery module. However, since the EOS protection circuit 12 is connected to the ground terminal v- of the cell monitoring circuit 11, which is connected to the blown bottommost fuse F0, most of the EOS bypasses the EOS protection circuit 12 and directly passes through the cell monitoring circuit 11, causing the cell monitoring circuit 11 to be damaged.

Hereinafter, a battery cell monitoring device equipped with an EOS protection circuit according to an embodiment of the present disclosure is described in detail with reference to FIGS. 4-6.

FIG. 4 is a schematic diagram showing a battery cell monitoring device equipped with an EOS protection circuit according to an embodiment of the present disclosure. The battery cell monitoring device equipped with the EOS protection circuit according to an embodiment of the present disclosure may be implemented as a cell monitoring unit (CMU).

Referring to FIG. 4, a battery cell monitoring device 100 according to an embodiment of the present disclosure may include a cell monitoring circuit 110, an EOS protection circuit 120, a first bypass circuit 130, a second bypass circuit 140, and the like.

The cell monitoring circuit 110 is a circuit that monitors each of a plurality of battery cells included in the battery module. The cell monitoring circuit 110 according to an embodiment of the present disclosure may be implemented as a battery monitoring integrated circuit (BMIC).

The cell monitoring circuit 110 monitors the status of each of n battery cells Cell 1 Cell n, where n is a natural number, included in the battery module and performs cell balancing. In an embodiment, the cell monitoring circuit 110 is equipped with n+1 voltage sensing terminals C0-Cn and n+1 cell balancing terminals S0-Sn.

The n+1 voltage sensing terminals C0-Cn are connected to positive and negative electrodes of the n battery cells Cell 1-Cell n through n+1 fuses F0-Fn to sense the voltage of the n battery cells.

Similarly, the n+1 cell balancing terminals S0-Sn are connected to the positive and negative electrodes of the n battery cells Cell 1-Cell n through the n+1 fuses F0-Fn to perform cell balancing for the n battery cells.

The EOS protection circuit 120 is a circuit for protecting the cell monitoring circuit 110 from external EOS. The EOS protection circuit 120 according to an embodiment of the present disclosure may include a transient voltage suppressor (TVS) diode.

For example, the EOS protection circuit 120 is connected between the uppermost terminal Sn of the cell monitoring circuit 110 and a ground terminal v-of the cell monitoring circuit 110 to protect the cell monitoring circuit 110 from the external EOS. The uppermost terminal Sn is connected to the positive electrode of the uppermost battery cell Cell n of the battery module through the uppermost fuse Fn, and the ground terminal v-is connected to the negative electrode of the bottommost battery cell Cell 1 of the battery module through the bottommost fuse F0.

The first bypass circuit 130 is connected between the uppermost terminal Sn of the cell monitoring circuit 110 and a first end of the next-uppermost fuse Fn-1, the first end being opposite to a second end that is connected to the positive electrode of the next-uppermost battery cell Cell n−1 of the battery module. The first bypass circuit 130 bypasses the externally introduced EOS, which flows in through the next-uppermost fuse Fn-1, to the EOS protection circuit 120.

For example, the first bypass circuit 130 may include a first Schottky diode connected between the uppermost terminal Sn of the cell monitoring circuit 110 and a first end of the next-uppermost fuse Fn-1, the first end being opposite to a second end that is connected to the positive electrode of the next-uppermost battery cell Cell n−1 of the battery module. The first bypass circuit 130 bypasses the externally introduced EOS, which flows in through the next-uppermost fuse Fn-1, to the EOS protection circuit 120.

In an embodiment, the first bypass circuit 130 may further include a second Schottky diode connected between the uppermost terminal Sn of the cell monitoring circuit 110 and a first end of the uppermost fuse Fn, the first end being opposite to a second end that is connected to the positive electrode of the uppermost battery cell Cell n of the battery module. The first bypass circuit 130 bypasses the externally introduced EOS, which flows in through the uppermost fuse Fn, to the EOS protection circuit 120.

For reference, according to an embodiment of the present disclosure, the uppermost terminal Sn of the cell monitoring circuit 110 is a terminal configured to perform cell balancing for the uppermost battery cell Cell n of the battery module.

In addition, the second bypass circuit 140 is connected between the ground terminal v-of the cell monitoring circuit 110 and a first end of the next-bottommost fuse F1, the first end being opposite to a second end that is connected to the negative electrode of the next-bottommost battery cell Cell 2 (i.e., the positive electrode of the bottommost battery cell Cell 1). When the bottommost fuse F0 is blown, the second bypass circuit 140 bypasses the externally introduced EOS through the next-bottommost fuse F1 for external discharge.

For example, the second bypass circuit 140 may include a third Schottky diode connected between a first end of a bead and a first end of the next-bottommost fuse F1, the first end of the bead being opposite to a second end that is connected to the ground terminal v- of the cell monitoring circuit 110, and the first end of the next-bottommost fuse F1 being opposite to a second end that is connected to the negative electrode of the next-bottommost battery cell Cell 2 (i.e., the positive electrode of the bottommost battery cell Cell 1). When the bottommost fuse F0 is blown, the second bypass circuit 140 bypasses the externally introduced EOS through the next-bottommost fuse F1 for external discharge.

When the EOS is introduced from the outside, the largest amount of EOS (e.g., approximately 50% of the total EOS energy) flows in through the uppermost fuse Fn, which is connected to the positive electrode of the uppermost battery cell Cell n of the battery module. The next largest amount of EOS (e.g., approximately 30% of the total EOS energy) flows in through the next-uppermost fuse Fn-1, which is connected to the positive electrode of the next-uppermost battery cell Cell n−1 of the battery module. In this manner, the amount of EOS introduced through each fuse F1-Fn progressively decreases, and the EOS introduced through the fuses flows into the battery cell monitoring device 100.

When the uppermost fuse Fn and the bottommost fuse F0 are in a normal state, as shown in FIG. 4, most of the introduced EOS passes through the EOS protection circuit 120 and is discharged to the outside. As a result, only a portion of the EOS affects the cell monitoring circuit 110, thereby protecting the cell monitoring circuit 110.

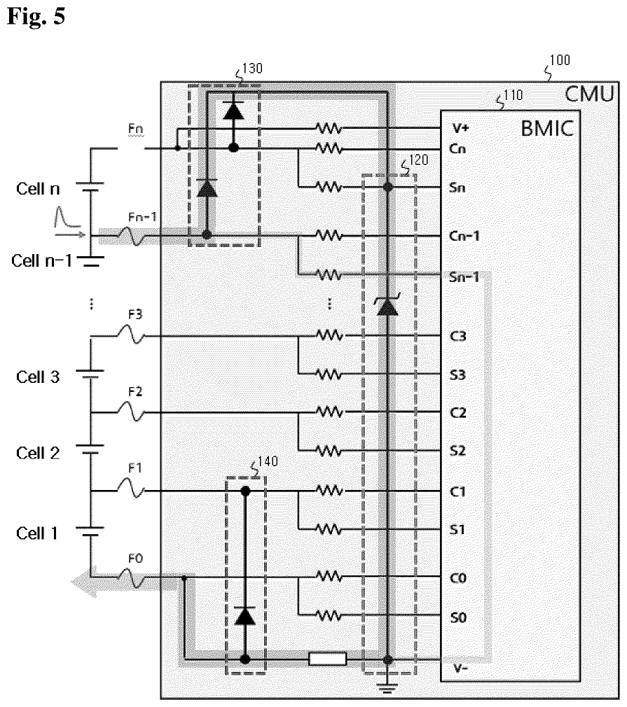

FIG. 5 is a diagram illustrating the effect of EOS on the battery cell monitoring device equipped with the EOS protection circuit according to an embodiment of the present disclosure when the uppermost fuse is blown.

Referring to FIG. 5, when the uppermost fuse Fn connected to the positive electrode of the uppermost battery cell Cell n of the battery module is blown, most of the introduced EOS flows in through the next-uppermost fuse Fn-1, which is connected to the positive electrode of the next-uppermost battery cell Cell n−1. The EOS then passes through the first bypass circuit 130 and the EOS protection circuit 120 before being discharged externally. As a result, only a portion of the EOS affects the cell monitoring circuit 110, thereby protecting the cell monitoring circuit 110.

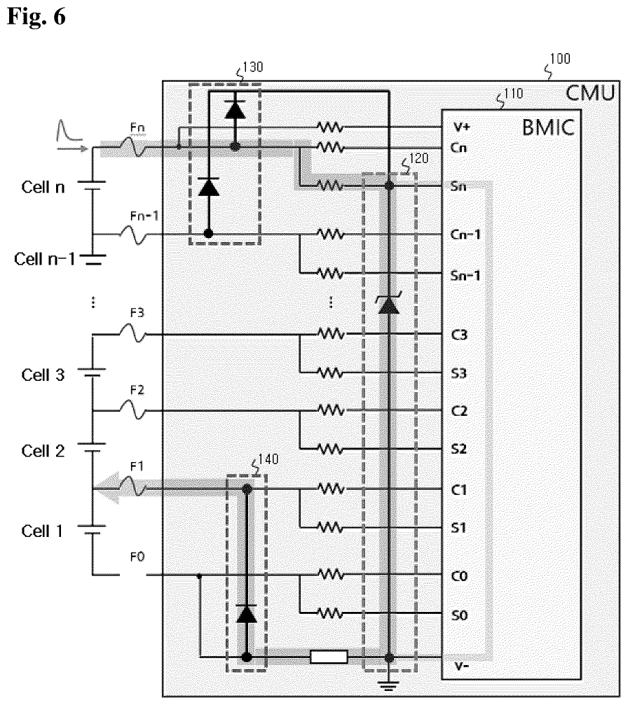

FIG. 6 is a diagram illustrating the effect of EOS on the battery cell monitoring device equipped with the EOS protection circuit according to an embodiment of the present disclosure when the bottommost fuse is blown.

Referring to FIG. 6, when the bottommost fuse F0 connected to the negative electrode of the bottommost battery cell Cell 1 of the battery module is blown, most of the introduced EOS flows in through the uppermost fuse Fn, which is connected to the positive electrode of the uppermost battery cell Cell n. The EOS then passes through the EOS protection circuit 120 and the second bypass circuit 140 before being discharged externally. As a result, only a portion of the EOS affects the cell monitoring circuit 110, thereby protecting the cell monitoring circuit 110.

As used in the present disclosure (especially in the appended claims), the terms “a/an” and “the” include both singular and plural references, unless the context clearly states otherwise. Also, it should be understood that any numerical range recited in the present disclosure is intended to include all sub-ranges subsumed therein (unless expressly indicated otherwise) and accordingly, the disclosed numeral ranges include every individual value between the minimum and maximum values of the numeral ranges.

The steps constituting the method according to the present disclosure may be performed in an appropriate order unless a specific order is described or otherwise specified. The present disclosure is not necessarily limited to the order in which the steps are recited. All examples described in the present disclosure or the terms indicative thereof (“for example”, “such as”, etc.) are merely to describe the present disclosure in greater detail. Therefore, it should be understood that the scope of the present disclosure is not limited to the example embodiments described above or by the use of such terms unless limited by the appended claims. Also, it should be apparent to those having ordinary skill in the art that various modifications, combinations, and alternations may be made depending on design conditions and factors within the scope of the appended claims or equivalents thereof.

The present disclosure is thus not limited to the example embodiments described above. Rather, the present disclosure is intended to include the following appended claims, and all modifications, equivalents, and alternatives falling within the spirit and scope of the following claims.

What is claimed is:

1. A battery cell monitoring device, comprising:
a cell monitoring circuit configured to monitor each of a plurality of battery cells included in a battery module;
an electrical overstress (EOS) protection circuit configured to protect the cell monitoring circuit from external EOS, the EOS protection circuit being connected between i) an uppermost terminal of the cell monitoring circuit, wherein the uppermost terminal of the cell monitoring circuit is connected to a positive electrode of an uppermost battery cell of the battery module and ii) a ground terminal of the cell monitoring circuit, wherein the ground terminal of the cell monitoring circuit is connected to a negative electrode of a bottommost battery cell of the battery module; and
a first bypass circuit configured to bypass the external EOS, wherein the first bypass circuit is connected between a positive electrode of a next-uppermost battery cell of the battery module and the uppermost terminal of the cell monitoring circuit.

2. The battery cell monitoring device according to claim 1, wherein the first bypass circuit comprises a first Schottky diode connected between the positive electrode of the next-uppermost battery cell of the battery module and the uppermost terminal of the cell monitoring circuit.

3. The battery cell monitoring device according to claim 2, wherein the first bypass circuit further comprises a second Schottky diode connected between the positive electrode of the next-uppermost battery cell of the battery module and the uppermost terminal of the cell monitoring circuit.

4. The battery cell monitoring device according to claim 1, further comprising a second bypass circuit configured to bypass the external EOS, wherein the second bypass circuit is connected between the ground terminal of the cell monitoring circuit and a positive electrode of the bottommost battery cell of the battery module.

5. The battery cell monitoring device according to claim 4, wherein the second bypass circuit comprises a third Schottky diode connected between the ground terminal of the cell monitoring circuit and the positive electrode of the bottommost battery cell of the battery module.

6. The battery cell monitoring device according to claim 1, wherein the uppermost terminal of the cell monitoring circuit is configured to perform cell balancing for the uppermost battery cell of the battery module.

7. The battery cell monitoring device according to claim 1, wherein the battery cell monitoring device is a cell monitoring unit (CMU).

8. The battery cell monitoring device according to claim 1, wherein the battery cell monitoring device is a battery monitoring integrated circuit (BMIC).

9. The battery cell monitoring device according to claim 1, wherein the EOS protection circuit comprises a transient voltage suppressor (TVS) diode.

10. A battery cell monitoring device, comprising:
a cell monitoring circuit configured to monitor each of a plurality of battery cells included in a battery module;
an electrical overstress (EOS) protection circuit configured to protect the cell monitoring circuit from external EOS, the EOS protection circuit being connected between i) an uppermost terminal of the cell monitoring circuit, wherein the uppermost terminal of the cell monitoring circuit is connected to a positive electrode of an uppermost battery cell of the battery module and ii) a ground terminal of the cell monitoring circuit, wherein the ground terminal of the cell monitoring circuit is connected to a negative electrode of a bottommost battery cell of the battery module; and
a bypass circuit configured to bypass the external EOS, wherein the bypass circuit is connected between the ground terminal of the cell monitoring circuit and a positive electrode of the bottommost battery cell of the battery module.

11. The battery cell monitoring device according to claim 10, wherein the bypass circuit comprises a Schottky diode connected between the ground terminal of the cell monitoring circuit and the positive electrode of the bottommost battery cell of the battery module.

12. The battery cell monitoring device according to claim 10, wherein the uppermost terminal of the cell monitoring circuit is configured to perform cell balancing for the uppermost battery cell of the battery module.

13. The battery cell monitoring device according to claim 10, wherein the battery cell monitoring device is a cell monitoring unit (CMU).

14. The battery cell monitoring device according to claim 10, wherein the battery cell monitoring device is a battery monitoring integrated circuit (BMIC).

15. The battery cell monitoring device according to claim 10, wherein the EOS protection circuit comprises a transient voltage suppressor (TVS) diode.
